(19) United States
(12) Patent Application Publication
(10) Pub. No.: US 2024/0391695 A1
(43) Pub. Date: Nov. 28, 2024

(54) VEHICLE MOUNTED SENSORS AND METHODS OF USING THE SAME

(71) Applicant: United States Postal Service, Washington, DC (US)

(72) Inventor: Leung Man Shiu, Gaithersburg, MD (US)

(21) Appl. No.: 18/673,173

(22) Filed: May 23, 2024

Related U.S. Application Data
(60) Provisional application No. 63/504,141, filed on May 24, 2023.

(51) Int. Cl. B65G 1/137; B66F 9/06; G06T 5/20; G06T 7/13; G06T 7/136; G06T 7/194; G06T 7/50

(52) U.S. Cl. CPC B65G 1/1371; B66F 9/063; G06T 5/20; G06T 7/13; G06T 7/136; G06T 7/194; G06T 7/50; B65G 2203/0216; B65G 2203/041; B65G 2203/046; G06T 2207/30261

(57) ABSTRACT

Systems, methods, and devices for scanning containers are described. An automatic scanning system is coupled to a vehicle that is configured to move containers within a warehouse. The automatic scanning system includes a sensor system that detects and locates a container relative to the sensor system. Based on the detected container being located within a suitable distance, the automatic scanning system triggers a lighting system and camera system. The triggered lighting system illuminates the item container and a placard positioned thereon. The camera system captures an image of the illuminated placard. The image of the placard is read by a computer, and based on the information on the placard, the item container is identified, and the vehicle or an operator thereof is instructed to move the item container to a location.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 63/504,141, the entire contents of which are hereby incorporated by reference.

### BACKGROUND

This disclosure relates to sensors, systems, methods of use, and methods of manufacture. In particular, this disclosure relates to sensors on autonomous guided vehicles or other vehicles that can read labels and computer readable codes.

### SUMMARY

Methods and apparatuses or devices disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description” one will understand how the described features provide advantages that include towing and connections.

In some aspects, the techniques described herein relate to an automatic scanning system including: a sensor system including one or more sensors, wherein the sensor system is configured to detect an item container; a camera system including one or more cameras, wherein the camera system is configured to capture an image of a label on an item container; and a control system configured to: connect to a vehicle; interpret sensor input from the sensor system; generate commands based on the interpreted sensor inputs to control the camera system.

In some aspects, the techniques described herein relate to an automatic scanning system, wherein the control system is further configured to: cause the sensor system to generate a background depth image of a ground surface of a facility to define a floor plane; cause the sensor system to generate a container depth image of an item container positioned on the ground surface of the facility; apply one or more pre-filters to the container depth image from the sensor system indicative of the item container; subtract the background depth from the container depth image; detect contours in the container depth image; and threshold the detected contours in the container depth image.

In some aspects, the techniques described herein relate to an automatic scanning system, wherein the control system is further configured to: determine whether the container depth image is indicative of a presence of the item container; determine whether the container depth image indicates that the item container is within a suitable distance of the sensor system to capture an image of the label on the item container; in response to determining that the container depth image is indicative of the presence of the item container and that the item container is within a suitable distance of the sensor system cause the camera system to capture an image of the label on the item container.

In some aspects, the techniques described herein relate to an automatic scanning system, wherein the control system is further configured to communicate the image of the label on the item container to a surface visibility system, wherein the surface visibility determines a destination for the item container based on the image of the label.

In some aspects, the techniques described herein relate to an automatic scanning system, wherein the sensor system includes an RFID reader system configured to read an RFID tag on the item container.

In some aspects, the techniques described herein relate to an automatic scanning system, wherein the camera system includes a control board connected to the vehicle, the control board configured to receive one or more inputs from the vehicle.

In some aspects, the techniques described herein relate to an automatic scanning system, wherein the input from the vehicle includes an indication of movement of the vehicle, and wherein the control board is configured to adjust a focus mechanism of the camera system to image on item containers based on the indication of movement.

In some aspects, the techniques described herein relate to an automatic scanning system, wherein the camera system further includes a gear, which, when operated, adjusts the focus mechanism.

In some aspects, the techniques described herein relate to an automatic scanning system, wherein the control board is configured to operate the gear based on the indication of movement.

In some aspects, the techniques described herein relate to an automatic scanning system, wherein the vehicle is an automated guided vehicle.

In some aspects, the techniques described herein relate to a method of operating a vehicle, the method including: detecting, via a sensor system located on a vehicle an item container; capturing, via a camera system located on the vehicle, an image of a label on an item container; interpreting, by one or more processors, sensor input from the sensor system; and generating, by the one or more processors, commands based on the interpreted sensor inputs to operate the camera system.

In some aspects, the techniques described herein relate to a method further including: generating, via the sensor system, a background depth image of a ground surface of a facility to define a floor plane; generating, via the sensor system, a container depth image of an item container positioned on the ground surface of the facility; applying, by the one or more processors, one or more pre-filters to the container depth image from the sensor system; subtracting, by the one or more processors, the background depth from the container depth image; detecting, by the one or more processors, contours in the container depth image; and thresholding, by the one or more processors, the detected contours in the container depth image.

In some aspects, the techniques described herein relate to a method further including: determining, in the one or more processors, that the container depth image is indicative of a presence of the item container; determining that the container depth image indicates that the item container is within a suitable distance of the sensor system to capture an image of the label on the item container; and in response to determining that the container depth image is indicative of the presence of the item container and that the item container is within a suitable distance of the sensor system, automatically causing the camera system to capture an image of the label on the item container.

In some aspects, the techniques described herein relate to a method, wherein the vehicle is an automated guided vehicle.

In some aspects, the techniques described herein relate to a method, wherein the sensor system includes an RFID reader, and wherein detecting, the item container system includes reading an RFID tag on the item container.

In some aspects, the techniques described herein relate to a method, further including, receiving, in the camera system, one or more inputs from the vehicle.

In some aspects, the techniques described herein relate to a method, adjusting a focus mechanism of the camera system in response to the one or more inputs from the vehicle.

In some aspects, the techniques described herein relate to a method, wherein the one or more inputs include an indication of movement of the vehicle.

In some aspects, the techniques described herein relate to a method, wherein adjusting the focus mechanism includes operating a gear connected to the focus mechanism based on the indication of movement of the vehicle.

In some aspects, the techniques described herein relate to a method wherein the one or more inputs include a speed and direction of the vehicle.

### BRIEF DESCRIPTION OF THE DRAWINGS

In the following detailed description, reference is made to the accompanying drawings, which form a part thereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure. Furthermore, similar features, such as similarly named and/or numbered features, of different embodiments referenced throughout this disclosure can have the same or similar characteristics apart from differences described herein.

FIG. 1 depicts an exemplary automated scanning system connected to a vehicle.

FIG. 2 depicts an exemplary item container with a placard.

FIG. 3A depicts an exemplary automated scanning system connected to a vehicle.

FIG. 3B is a view of the automated scanning system of FIG. 3A.

FIG. 4 depicts an exemplary forklift adapted for an automated scanning system.

FIG. 5 is a block diagram of an exemplary automated scanning system.

FIG. 6A depicts an exemplary sensor system.

FIG. 6B is an exploded view of the sensor system of FIG. 6A.

FIG. 7 illustrates an exemplary camera system.

FIG. 8A illustrates an exemplary image of the ground surface of a warehouse.

FIG. 8B illustrates an exemplary depth image of the ground surface of the warehouse shown in FIG. 8A.

FIG. 9A illustrates an exemplary image of an item container on the ground surface of a warehouse.

FIG. 9B illustrates an exemplary depth image of the item container on the ground surface of the warehouse shown in FIG. 9A.

FIG. 9C illustrates the depth image of FIG. 9B after pre-filters have been applied.

FIG. 10 illustrates the depth image of FIG. 9C with the background depth removed.

FIG. 11A illustrates the depth image of FIG. 10 with the contours detected.

FIG. 11B illustrates the depth image of FIG. 11A after thresholding the contours.

FIG. 12 illustrates an exemplary method of triggering a camera and lighting system to capture an image of a placard with computer readable code that can be read by a computer.

### DETAILED DESCRIPTION

Although certain embodiments and examples are described below, this disclosure extends beyond the specifically disclosed embodiments and/or uses and obvious modifications and equivalents thereof. Thus, it is intended that the scope of this disclosure should not be limited by any particular embodiments described below.

The quantity of items, such as packages and parcels, being delivered to homes and businesses is rising. Often large quantities of items need to be moved quickly and efficiently. Consequently, distribution networks, such as the United States Postal Service (USPS), can employ vehicles, such as automated guided vehicles (AGVs), to move, lift, push, tow, etc., one or more item containers, such as rigid and collapsible containers, wire containers, pallets, wheeled shelves, bins, pouches, bags, containers, and other rolling stock, to move large quantities of items in an efficient manner. Placards, labels, signs, and the like can be coupled to the item container to provide computer readable information (e.g., computer readable codes, barcodes) regarding the item container and items contained therein, such as destination, route, arrival, departure, item category, and/or other information. A camera system coupled to the vehicle can identify the location of a container, read the placard on the container, and, based on the read information, quickly and efficiently identify an intended destination for the item. The system can then move or direct an AGV vehicle or a driver of the vehicle to move the item container and its contents to the intended location for further processing, loading onto a transportation vehicle, or other locations within a warehouse. This efficiency and speed, however, is impeded when the camera system captures an image of the placard that cannot be readily read or interpreted, which can result from improper focus, early image capture (e.g., when the camera system is too far away from the placard), and/or other causes. This can happen when, for example, a vehicle is moving and trying to image a container and label thereon. The movement of the vehicle changes the focus, field of view, and depth of field needed to take a clear image and computer readable code that can be interpreted quickly and accurately.

Accordingly, distribution networks can use automatic scanning systems to locate item containers relative to the vehicle. As used herein, scanners can include sensors, cameras, detectors, RF transceivers, and the like. An automatic scanning system, and/or camera system can trigger the camera system when the item container is within a suitable distance to capture a suitable image of the placard that can be properly imaged and read. This can advantageously improve placard image quality, which can in turn increase the accuracy, efficiency, and speed of item movement within a warehouse. Furthermore, the automatic scanning system can verify the identity of an item container before a vehicle, such as an automated guided vehicle (AGV), moves the item container to ensure that the destination location is correct. In addition, the auto-scan system can include auto-focus mechanisms that automatically adjust the focus of the camera system based on the speed of the vehicle, or other parameters, to further improve placard image quality.

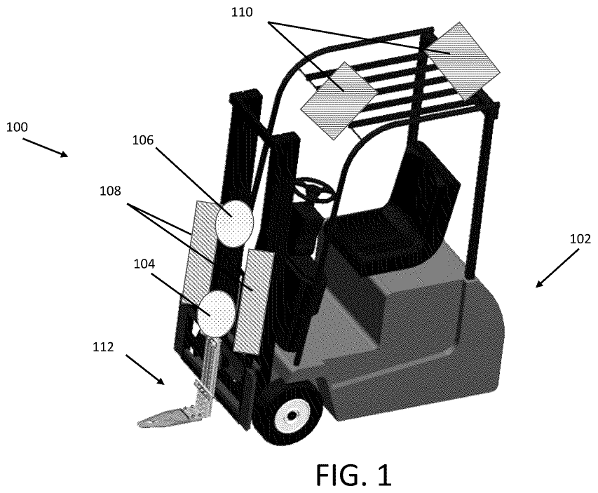

FIG. 1 illustrates an embodiment of an automated scanning system 100. The automated scanning system 100 is coupled to the vehicle 102, which can be, for example, an AGV, forklift, tug, etc. Although a vehicle with a driver's seat is depicted, the vehicles 102 described herein can be automated or driverless vehicles, or can be operated by a driver. The automated scanning system 100 includes a sensor system 104 that scans an area of a facility for item containers, such as wheeled shelving units, rigid and collapsible wire containers, pallets, wheeled shelves, bins, pouches, bags, containers, and rolling stock. The sensor system 104 can detect, locate, and/or map the position of a scanned item container and other items relative to the vehicle 102, sensor system 104, and/or a camera system 106. The sensor system 104 can differentiate and locate item containers from the surrounding environment and/or other objects. The sensor system 104 can determine the distance between the scanned item container and the vehicle 102, sensor system 104, and/or a camera system 106.

The sensor system 104 can include one or more of the following: an optic sensor, photo sensor, light sensor, video camera sensor, camera sensor, depth camera sensor, radar sensor, infrared sensor (including infrared laser mapping), thermal sensor, laser sensor, LiDAR sensor, proximity sensor, capacitive sensor, ultrasonic sensor, 3D sensor, and/or any combination of sensors used to map an environment/object(s) and/or determine depth, distance, presence, movement, etc. The sensor system 104 or the sensors thereof can be positioned in a variety of locations on the vehicle 102.

The sensor system 104 and/or the sensors thereof can be positioned on the vehicle 102 such that the sensor system 104 and/or the sensors thereof are less than 1, 1-2, 2-3, 3-4, 4-5, 5-6, 6-7, or greater than 7 feet off a ground surface. In some embodiments, the sensor system 104 and/or the sensors thereof are positioned on the vehicle 102 such that the sensor system 104 and/or the sensors thereof are positioned 3 feet off the ground surface, which can advantageously position the sensor system 104 and/or the sensors thereof relative to the height of the placard. In some embodiments, the sensor system 104 and/or the sensors thereof are positioned on the vehicle 102 at higher heights (e.g., 6 feet off the ground surface) and the sensor system 104 and/or the sensor(s) thereof are angled downward to view the ground surface and objects thereon. At higher positions, the risk of damage to the sensor system 104 and/or sensors can be reduced. In some embodiments, the sensor system 104 can be activated by the vehicle 102, such as an AGV, as the vehicle 102 approaches the detected and/or anticipated location of the item container.

The automated scanning system 100 can include and/or be in communication with a camera system 106 and lighting system 108 that are coupled to the vehicle 102. The lighting system 108 can illuminate a placard on the item container sensed by the sensor system 104. The lighting system 108 can include one or more lighting units (e.g., LEDs), such as 1, 2, 3, 4, 5, 6, or more lighting units. The lighting system 108 and/or lighting unit(s) thereof can be positioned on the vehicle 102 such that the lighting system 108 and/or lighting unit(s) thereof are less than 1, 1-2, 2-3, 3-4, 4-5, 5-6, 6-7, or greater than 7 feet off a ground surface.

The lighting system 108 can be triggered by the automated scanning system 100 and/or sensor system 104. The lighting system 108, upon triggering, can illuminate an item container such that the placard containing computer readable code is more visible to the camera system 106. In some embodiments, the lighting system 108 provides illumination upon triggering and ceases to provide illumination once the camera system 106 captures an image. In some embodiments, the lighting system 108 provides illumination upon triggering and continues to provide illumination until a pre-determined time period has expired. In some embodiments, the lighting system 108 provides illumination upon triggering and continues to provide illumination until a predetermined time period has expired after the camera system 106 captures an image of the placard. The lighting units of the lighting system 108 can be angled downward to direct light toward item containers and placards. In some embodiments, the lighting units of lighting system 108 can be attached to the vehicle 102 with actuators or motors able to move the lighting units into the ideal position for illuminating an item container.

The camera system 106 can include one or more cameras. The one or more cameras can be digital cameras of varying resolutions, which can include less than 1 megapixel, 1-5 megapixels, 5-10 megapixels, 10-15 megapixels, 15-20 megapixels, 20-25 megapixels, or greater than 25 megapixels. The camera system 106 can include a high resolution camera with controllable focus, such as a Cognex™ camera. The camera system 106 can capture an image of a placard that can be read or interpreted by one or more processors. The one or more processors can be part of the camera system 106, or the camera system 106 can include a communications features configured to send and receive communication between a server remote from the vehicle 102. The camera system 106 can, in some embodiments, focus on item containers and/or placards at varying distances. The camera system 106 can automatically change focus based on the speed of the vehicle 102.

The camera system 106 can automatically change focus based on the distance between the camera of the camera system 106 and the subject item container and/or placard thereon. The camera system 106 and/or a camera thereof can be positioned on the vehicle 102 such that the camera system 106 and/or camera thereof are less than 1, 1-2, 2-3, 3-4, 4-5, 5-6, 6-7, or greater than 7 feet off a ground surface. In some embodiments, the camera system 106 and/or a camera thereof are positioned on the vehicle 102 at higher heights (e.g., 6 feet off the ground surface) and the camera system 106 and/or a camera thereof are angled downward to view the ground surface and objects thereon. At higher positions, the risk of damage to the camera system 106 can be reduced. Higher camera positions can, however, result in a larger distance between the camera and the placard 202, which can decrease the readability of the captured placard image. Higher camera positions can also require the captured images to be pre-processed to counter the skew induced by the downward-angled camera. Higher camera positions can require a deeper depth of field to accommodate the camera's downward angle, which can compromise performance in low light areas. In some embodiments, the camera system 106 and/or a camera thereof are positioned on the vehicle 102 such that camera system 106 and/or a camera thereof are positioned 3 feet off the ground surface, which can advantageously position the camera system 106 and/or a camera relative to the height of the placard such that the camera can be aimed horizontally relative to the ground surface.

Camera height positions that are at approximately the same height as placards (e.g., approximately 3 feet off the ground surface) can eliminate or reduce the need to pre-process images to counter image skew induced by cameras viewing an object or item at an angle other than straight on. Camera height positions that are at approximately the same height as placards (e.g., approximately 3 feet off the ground surface) can reduce the distance between the camera and placard 202, improving the readability of the captured placard image. Camera height positions that are at approximately the same height as placards (e.g., approximately 3 feet off the ground surface) can reduce the required depth of field, which can improve performance in low light areas. In some embodiments, different lens apertures can be used to balance image brightness with depth of field. In some embodiments, different exposure time and sensor gain settings can be implemented to improve image quality. In some embodiments, different exposure times can be implemented based on the distance to the item container, while avoiding overexposure.

In use, the sensor system 104 can detect and locate an item container and determine the distance between the item container and the vehicle 102, automated scanning system 100, sensor system 104, and/or the camera system 106. In some embodiments, the sensor system 104 can determine the position of the scanned item container relative to the vehicle 102, automated scanning system 100, sensor system 104, and/or the camera system 106. The automated scanning system 100 can differentiate between item containers and the surrounding environment and/or other objects. The automated scanning system 100 can determine that the item container is within a suitable distance range of the vehicle 102, automated scanning system 100, sensor system 104, and/or the camera system 106 and, as a result, trigger the camera system 106 and lighting system 108. The triggered lighting system 108 illuminates an item container such that a placard thereon is illuminated. The triggered camera system 106 captures an image of the illuminated placard. In some embodiments, the camera system 106 captures an image of the illuminated placard when the camera of the camera system 106 is within a suitable distance of the vehicle 102. In some embodiments, the camera system 106 captures an image of the illuminated placard when the vehicle 102 is still in motion. The camera system 106 can automatically focus to accommodate for the motion of the vehicle 102 and/or the changing distance between the camera of the camera system 106 and the item container and/or placard.

The computer readable information on the placard can be read by the automated scanning system 100 or communicated to another system, such as a surface visibility system (e.g., surface visibility database), or remote server for reading. Based on the read information, the automated scanning system 100 or another system, such as the surface visibility system, can identify the item container and/or direct the vehicle 102 or a driver of the vehicle 102 to transport the item container to a location within the warehouse (e.g., loading dock, location for sortation). An automatic hitching system 112 can enable the vehicle 102 to automatically hitch to an item container for efficient and prompt item container movement.

The automated scanning system 100 can include and/or be in communication with a radio-frequency identification (RFID) reader system 110. The RFID reader system 110 can read RFID tags throughout the warehouse as the vehicle 102 travels therethrough. The placards, referenced herein, can have associated RFID tags that contain information that is the same or similar to the computer readable information on the placards or more information. The RFID reader system 110 can read RFID tags as the vehicle 102 completes tasks throughout a warehouse, such as transporting an item container from a pick location to a drop location. The location of the read RFID tags within the warehouse can be relayed to a surface visibility system. The surface visibility system can record the location and/or status of vehicles 102, items, item containers, placards, operators, transportation vehicles, and/or other objects that have an associated RFID tag. Accordingly, the RFID reader system 110 can provide updated information regarding the location of RFID tags and associated objects, enabling the surface visibility system to maintain updated location and/or status records. Although described herein as an RFID reader system, the RFID reader system 110 can employ sensing and detection functions via other communications protocols, such as Bluetooth, Wi-Fi, ZigBee, and any other desired wireless communication method, system, or protocol.

In some embodiments, the RFID reader system 110 can also include sensors and/or detectors to communicate with static sensors placed within a facility. The sensors on the vehicle 102 can be used to identify the position of the vehicle 102 within the facility.

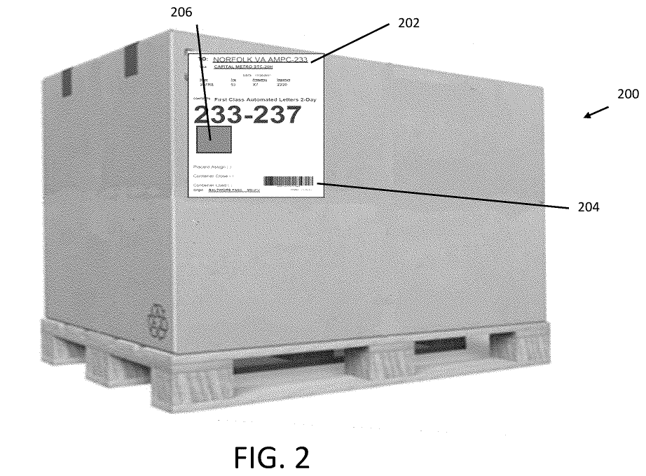

FIG. 2 illustrates an embodiment of an item container 200. The item container 200 can be a pallet, box, bin, bag, container, rolling stock, wheeled shelf, and/or rigid and collapsible wire containers to move large quantities of items in an efficient manner. Items can include boxes, parcels, letters, packages, and/or other articles that are processed by distribution networks. The item container 200 has a placard 202 coupled thereto. The placard 202 has computer readable code/information regarding the item container 200 and/or the items located therein. The computer readable information can encode or be associated with at least information regarding item destinations (e.g., intermediate, final), item container destinations (e.g., intermediate, final), route (e.g., route numbers, trip numbers, arrival times, departure times), category of items, ZIP Codes™ (e.g., destination of items and/or item container), regional codes (e.g., final or intermediate destination of items and/or item container), sortation, and/or other information for distribution. In some embodiments, the placard 202 can include information that is readable by human operators.

The placard 202 includes a computer readable code 204 and an RFID tag 206 or other type of tag. In some embodiments, the placard 202 includes either a computer readable code 204 or a RFID tag 206. The RFID reader system 110 can read the RFID tag 206. The tags can be active, passive, or semi-passive tags. When active, the RFID tag 206 can have a transceiver and power source (e.g., battery) such that the power source can run a chip's circuitry, and the transceiver can receive and broadcast signals between the RFID tag and the RFID reader system 110. When passive, the RFID tag 206 can have reduced components, relying on the power of the RFID reader system 110 to send out electromagnetic waves that induce a response from the RFID tag 206. When semi-passive, the RFID tag 206 can have a battery to run a chip's circuitry but rely on the electromagnetic waves of the RFID reader system 110 to communicate.

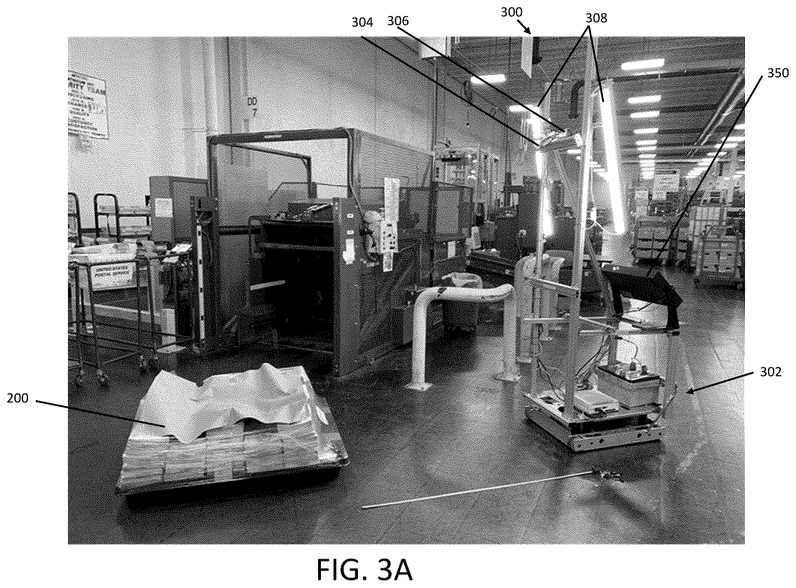

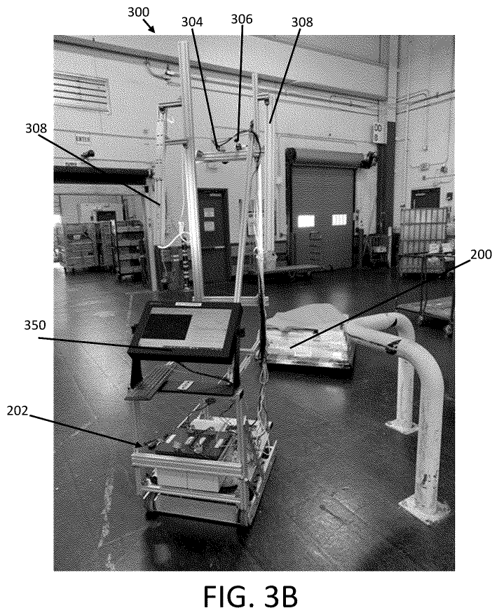

FIGS. 3A-3B illustrate an embodiment of an automated scanning system 300 coupled to a vehicle 302. The automated scanning system 300 has a sensor system 304, camera system 306, and lighting system 308. The sensor system 304 is positioned at a location on the vehicle 302 such that the sensor system 304 and/or a sensor thereof is/are positioned approximately 6 feet off the ground, but as indicated above, other heights are within the scope of the current disclosure. The sensor of the sensor system 304 is angled downward to scan item containers positioned on the ground. The camera system 306 and/or a camera thereof are positioned at a location on the vehicle 302 which can be the same as the sensor system 304, such that the camera system 306 and/or the camera thereof are positioned approximately 6 feet off the ground. But as indicated above, other heights are within the scope of this disclosure. The lighting system 308 and two lighting units thereof are positioned at a location on the vehicle 302 such that the lighting system 308 and/or two lighting units thereof extend at least 6 feet off the ground. The lighting units of the lighting system 308 are angled downward to illuminate placards. As illustrated, the lighting system 308 has been triggered such that the lighting system 308 is emitting light to illuminate the item container 200 and any placard thereon. The automated scanning system 300 includes a display 350 that can display information to an operator regarding destination information, images captured by the camera system 304, information read from the placard 202, route information, commands from the surface visibility system, and/or other information.

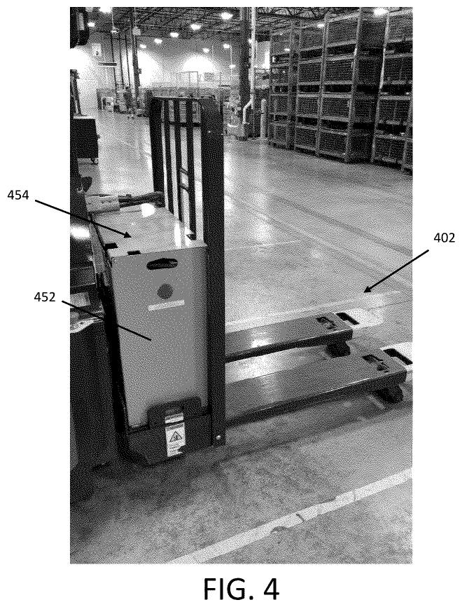

FIG. 4 depicts an embodiment of a forklift 402. The forklift 402 has a battery 452. Above the battery 452 is a space 454 where an automated scanning system 100, 300 can be positioned. This position can advantageously position the automated scanning system 100, 300 and associated cameras, lights, and/or sensors at a position above the ground surface such that the cameras, lights, and/or sensors can be aimed horizontally at placards and item containers, which can include heights detailed above.

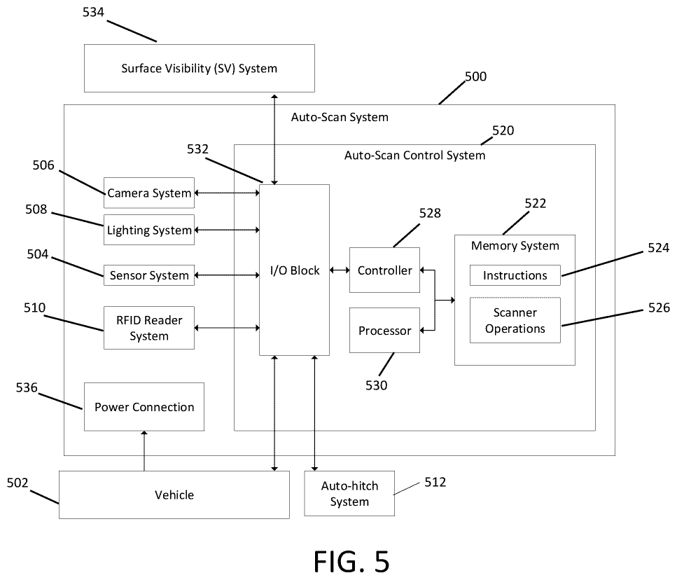

FIG. 5 schematically illustrates an embodiment of an automated scanning system 500. The automated scanning system 500 includes a control system 520. The architecture of the control system 520 can include an arrangement of computer hardware and software components used to implement aspects of the present disclosure. The control system 520 may include more or fewer elements than those shown in FIG. 5. It is not necessary, however, that all of these elements be shown in order to provide an enabling disclosure.

The control system 520 comprises an I/O block 532, controller 528, one or more processors 530, and memory system 522, all of which are in communicating connection with one another. The control system 520 and/or auto-scan system can be powered by a power source on the vehicle 502 via a power connection 536. In some embodiments, the automated scanning system 500 and/or control system 520 are powered by a battery or batteries. The control system 520 can include a data connection to a surface visibility (SV) system 534, vehicle 502, auto-hitch system 512, camera system 506, lighting system 508, sensor system 504, and/or RFID reader system 510. These systems can be similar to those describes elsewhere herein. The control system 520 can relay data directly or through a network relay. In some embodiments, the control system 520 communicates with the SV system 534, vehicle 502, auto-hitch system 512, camera system 50, lighting system 508, sensor system 504, and/or RFID reader system 510 in other manners, which can include wirelessly, such as with Bluetooth, radio, Wi-Fi, and/or other suitable manners.

The one or more processors 530 can read and/or write to memory system 522 and can execute instructions 524 and/or scanner operations 526 on memory system 522 to perform methods and tasks disclosed herein. The one or more processors 530 can be a microprocessor, Intel CORE i9®, i7®, i5®, or i3® processor, or combination of cores, an AMD Ryzen®, Phenom®, A-Series®, or FX® processor, or any other type of microprocessor. The one or more processors 530 typically has conventional address lines, conventional data lines, and one or more conventional control lines and comprise one or more cores. The one or more processors 530 may be in communication with a processor memory, which may include, for example, RAM memory, flash memory, ROM memory, EPROM memory, EEPROM memory, registers, hard disk, a removable disk, a CD-ROM, or any other form of storage medium known in the art. The processor memory may include, for example, software, at least one software module, instructions, steps of an algorithm, or any other information. In some embodiments, the one or more processors 530 performs processes in accordance with instructions stored in the processor memory. In some embodiments, other controllers or computing systems can be used.

As used herein, scanner operations 526 encompasses procedures, program code, or other logic that initiates, modifies, directs, and/or eliminates one or more camera, light, sensor, RFID reader, and/or vehicle functions. In some embodiments, instructions 524 encompass procedures, program code, or other logic that initiates, modifies, directs, and/or eliminates one or more scanner operations 526 or other operations necessary or advantageous for the methods described herein. In some embodiments, one or more portions of the memory system 522 can be remotely located from the automated scanning system 500, such as on a server or other component of a distribution facility network and can be in wired or wireless communication with the controller 528 and one or more processors 530.

The I/O block 532 receives, communicates, and/or sends commands, information, and/or communication between the control system 520 and other components of the automated scanning system 500 or other external devices and/or systems, such as the surface visibility (SV) system 534, vehicle 502, and/or auto-hitch system 512. The I/O block 532 can connect to the camera system 506, lighting system 508, sensor system 504, and/or RFID reader system 510.

The controller 528 can, which can include cooperation with the I/O block 532, interface between peripheral systems or devices, such as the surface visibility (SV) system 534, vehicle 502, and/or auto-hitch system 512. The controller 528 can provide a link between different parts of the control system 520, such as between the I/O block 532 and the memory system 522. The controller 528 can generate commands to effectuate the instructions 524 and/or scanner operations 526. The controller 528 can comprise a processor and/or programmable logic controller (PLC).

The memory system 522 can generally include RAM, ROM, and/or other persistent auxiliary or non-transitory computer-readable media. The memory system 522 can store an operating system that provides computer program instructions for use by the one or more processors 530 in the general administration and operation of the automated scanning system 500. The instructions 524 when executed by the one or more processors 530, can cause the automated scanning system 500 to receive sensor input from the sensor system 504 indicative of the location of a container, objects, people, vehicles, and/or other things in the vicinity of the automated scanning system 500. The instructions 524, when executed by the one or more processors 530 can cause the system to interpret sensor input to determine scanner operation(s) 526 that are a desirable, appropriate, and/or correct response to and/or associated with the received sensor input. The automated scanning system 500 can effectuate the designated scanner operation 526, which can include the one or more processors 530 generating commands via the controller 528 to effectuate the operation(s). The scanner operations 526 can at least include the methods described herein.

As disclosed elsewhere herein, the surface visibility system 534 is in communication with the automated scanning system 500 and control system 520. The surface visibility system 534 is a system that records and stores the location of surface transportation resources, such as vehicles 502, within a distribution network. The surface visibility system 534 can also store the locations of items to be moved within a facility, dock assignments for facilities, vehicle schedules and timing, and the intended destinations for those items. The surface visibility system 534 can be in connection with one or more other network resources that provide, in part or in full, the functionality described herein for the surface visibility system 534. In some embodiments, the surface visibility system 534 can receive an image of a placard captured by the camera system 506 and interpret, read, and/or extract information regarding the item, including for example, intended destination, service class, special handling instructions, dock assignment, etc. Based on the read information, the surface visibility system 534 can identify the item container and instruct the vehicle 502 and/or the driver of the vehicle 502 to move the item container, upon which the placard is positioned, to a new destination. In some embodiments, the control system 520 can read the placard captured by the camera system 506 and communicate the read information to the surface visibility system 534. In some embodiments, the surface visibility system 534 can record, which can include log, the location of RFID tags that are read by the RFID reader system 510, which can be indicative of the location and/or status of vehicles 102, items, item containers, placards, operators, transportation vehicles, and/or other objects.

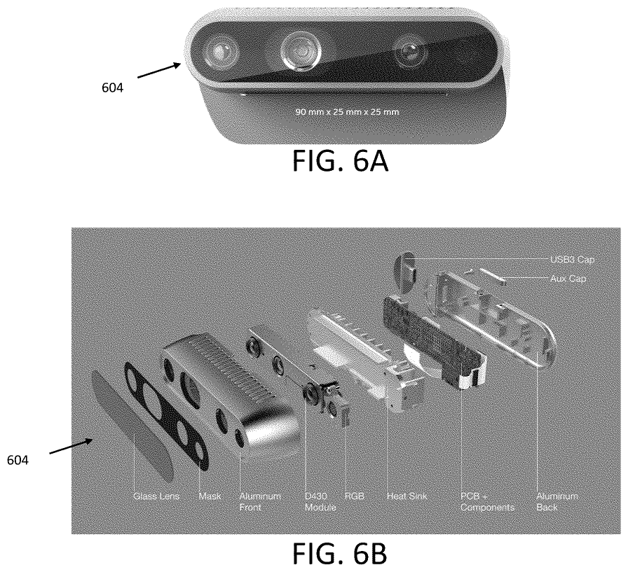

FIGS. 6A and 6B illustrate an embodiment of a sensor system 604. The sensor system 604 includes one or more sensors, which can include those described elsewhere herein, such as a 3D sensor. The sensor system 604 individually or in communication with the control system 520 can detect, locate, and/or map the position of a scanned item container and other items or environment relative to the vehicle and/or sensor system 604. The sensor system 604 can gather depth images (e.g., map out) a ground surface of a warehouse to set a background depth (e.g., floor plane). The sensor system 604 can gather depth image(s) of item container(s), which can be referred to as container depth image(s). The sensor system 604 alone or in communication with the control system 520 can isolate a scanned object within the container depth image, and based on the object distance, shape, size, and/or movement, determine whether an item container is present in the container depth image. The sensor system 604 or auto-scan system can determine the distance and/or relative position between the sensor system 604 and/or vehicle and the item container. The sensor system 604 alone or in communication with the control system 520, based on the determination, can trigger a camera system and/or lighting system to capture an image of a placard positioned on the item container. In some embodiments, the sensor system 604 utilizes stereo infrared vision with an internal dot projector to perform some or part of the tasks detailed herein. In some embodiments, the sensor system 604 includes a camera, which can be a color (e.g., RGB) camera. In some embodiments, the sensor system 604 is the Intel® RealSense™ D435.

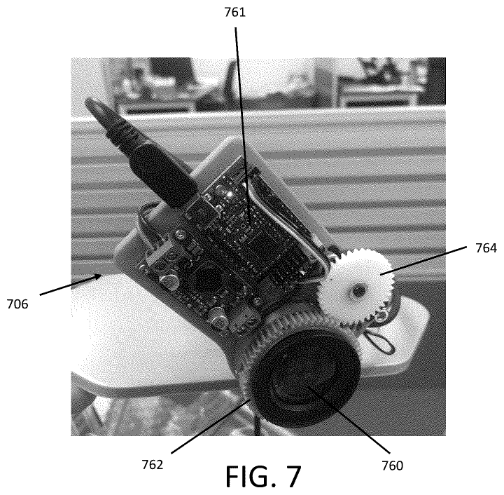

FIG. 7 illustrates an embodiment of a camera system 706. The camera system 706 can have one or more cameras 760. The camera 760 can be a camera of varying resolutions, as detailed elsewhere herein. The camera 760 has a controllable focus that enables the camera system 706 to capture images of placards at varying distances, accommodate for the changing distance between the camera 760 and the subject placard, and/or accommodate or change focus based on movement of the vehicle.

The camera system 706 can include a ring gear 762, a gear 764, and a control board 761. The ring gear 762 is connected to the focus control of the camera 760. As shown, the focus control can cause rotational movement of the camera lens. The ring gear 762 is in mechanical communication with a gear 764. When the gear 764 rotates, the ring gear 762 rotates, and the focus of the camera 760 can change. The gears can be sized and the speed controlled to provide the desired rate of change of the focus control of the camera 760.

The control board 761 is in electrical communication with the vehicle to which the camera system 706 is attached. The control board 761 can receive an input from the vehicle corresponding to movement or speed. The control board can control a servo or motor. The servo or motor is connected to the gear 764 and is configured to move or spin the gear 764.

For example, in some embodiments, the focus of the camera 160 can be altered based, at least in part, on the movement of the vehicle. In some embodiments, the control board 761 receives a signal indicative of movement of the vehicle 102. The control board 761 causes a servo or motor to rotate the gear 764. The rotation of the gear 764 in turn rotates the gear 762. The camera 760, via the control board 761 and other components of the camera system 706 can establish an initial focus, such as when the camera is activated, or when the item is detected by the item sensor system 504 or the camera system 706. Once the initial focus is set, the control board can move the gear 764 a known amount for every unit distance travelled. Using known features of the lens and other components of the camera 760, the gear 764 can be moved the proper amount based on the distance travelled in order to keep the item or container in focus. Thus, as a vehicle moves forward, for example, toward an item having a placard thereon, the focus of the camera 760 can be continuously or step-wise adjusted to keep the item container, or a label/placard/tag/etc. thereon, in focus as the vehicle moves toward it.

This can advantageously enable the camera 160 to bring or keep a target placard in focus while the vehicle is in motion such that a suitable image for computer reading is captured by the camera system 706. In some embodiments, the rotation of the gear 762 can be tied to the motor of the vehicle.

In some embodiments, the focus of the camera 760 can be controlled by a motor, such as a stepper motor. In some embodiments, the gear 762 can be controlled by a stepper motor such that full rotation of the gear 762 corresponds to a number of equal steps. The motor's position can be directed to move and hold at one of the steps. In some embodiments, the rotation of the gear 762 can be tied to movement of the vehicle upon which the camera system 706 is coupled.

In some embodiments, the servo or motor on the control board 761 can directly interact with the focus control mechanism of the camera, adjusting the camera 760 focus directly, without the need for the gear 764 and the ring gear 762.

In some embodiments, the control board 761 can receive a signal regarding the direction of movement of the vehicle relative to the container. The direction of movement of the vehicle can be determined based on a positioning system of the vehicle. When the control board 761 receives signals that the vehicle is moving toward an item container, the control board 761 moves the gear 762 to maintain focus of the camera 760. When the control board 761 receives a signal that the vehicle is moving away from an item container, the control board 761 movers the gear 762 in a different direction, for example, in an opposite direction, in order to maintain the camera 760 in focus on the item container and/or the placard thereon.

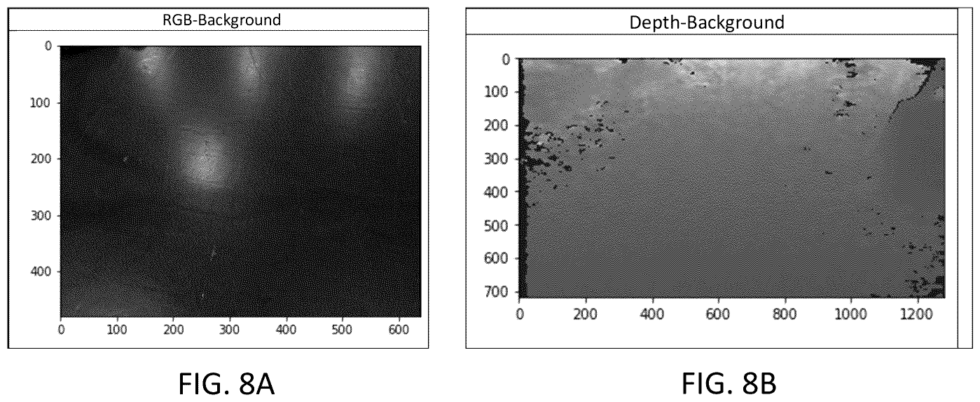

In use, the sensor systems 504 described herein can detect and locate an item container 200 such that the camera systems 506 and lighting systems 508 described herein can capture computer readable images of a placard 202 thereon, which can provide information regarding the item container 200 and to where the item container 200 should be directed. The sensor systems 504 described herein can establish a floor plane of a warehouse, such that scanned item containers can be recognized against the background floor plane of the warehouse. For example, FIG. 8A illustrates an image (e.g., RGB image, color image, black and white image) of the ground surface of a distribution facility. FIG. 8B illustrates a depth image captured by the sensor system 504 of the ground surface of the warehouse depicted in FIG. 8A such that a background depth (e.g., floor plane) is established. The background depth image can be used in subsequent imaging or scanning processes to set a reference value for sensing items and item containers.

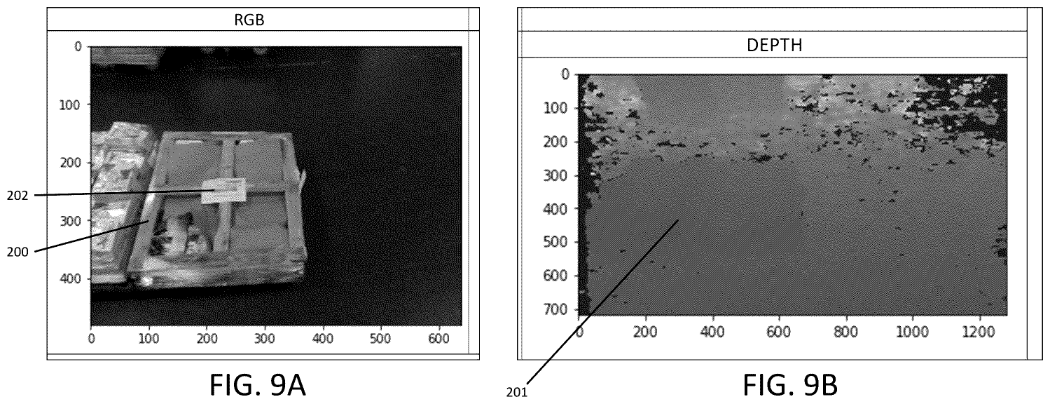

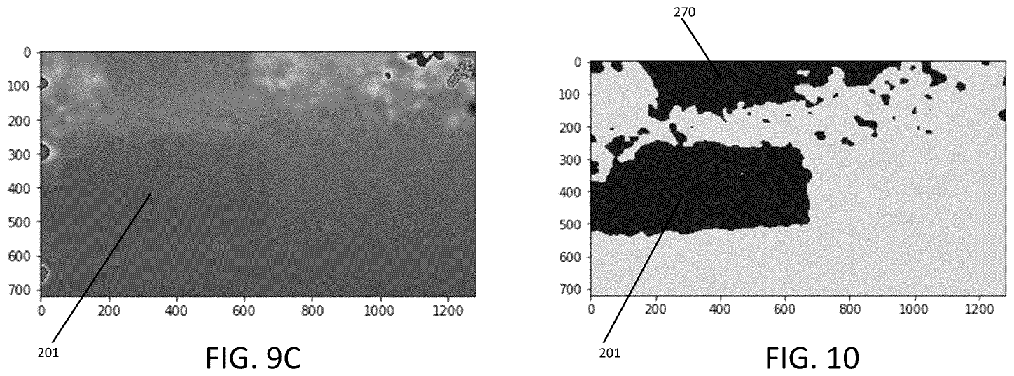

The sensor system 504 can capture a depth image of an item container 200 that is positioned on the ground surface of the distribution, for example, on the established floor plane. For example, FIG. 9A illustrates an image (e.g., RGB image, color image, black and white image) of an item container 200 with a placard 202 thereon, positioned on the ground surface of the warehouse identified in FIG. 8A above. FIG. 9B illustrates a depth image captured by the sensor system 504 of the item container 200 positioned on the ground surface of the warehouse illustrated in FIG. 9A—also referred to as a container depth image. As shown in FIG. 9B, the item container 200, shown as the item container image 201, can be recognized given that the item container 200 is at a different depth than the surrounding floor plane.

The sensor system 504 and/or the automated scanning system 500 can apply pre-filters to the container depth image of FIG. 9B to prepare the container depth image for processing, as shown in FIG. 9C. The sensor system 504 and/or the automated scanning system 500 can subtract the background depth from FIGS. 8A and 8B (e.g., floor plane) from the container depth image (FIGS. 9A, 9B, 9C), with the result shown in FIG. 10. The container depth image with the subtracted background depth leaves the item container image 201 and an object(s) image 270. The object(s) image 270 can indicate objects other than the subject item container that are present in the container depth image with the subtracted background depth, and as explained elsewhere herein, the sensor system 504 and/or the automated scanning system 500 can determine that the object(s) image 270 is not indicative of an item container and that the object(s) image 270 should be removed and/or should not trigger the processes to capture an image of a placard thereon.

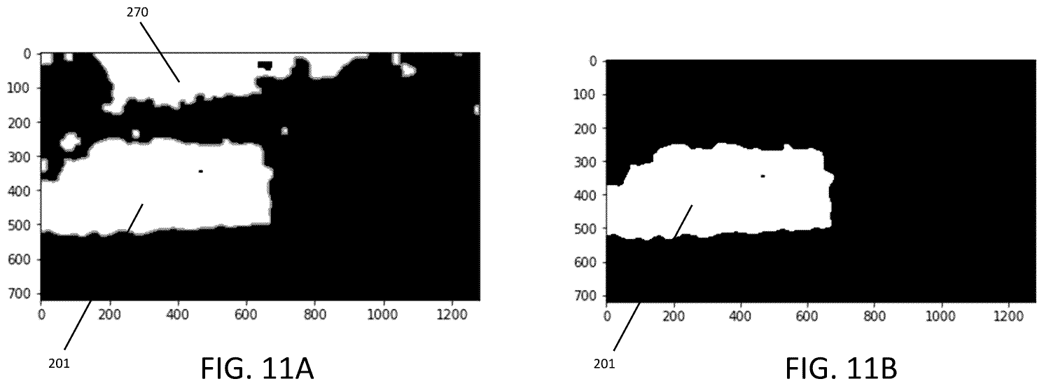

The sensor system 504 and/or the automated scanning system 500 can detect (e.g., find) the contours shown in the container depth image with the subtracted background, as shown in FIG. 11A. This can remove at least some of the extraneous depth indications that do not represent an item container and/or other object that were present in the container depth image shown in FIG. 10. The sensor system 504 and/or the automated scanning system 500 can threshold the detected contours of FIG. 11A, with the results shown in FIG. 11B. Thresholding the detected contours can smooth the detected contours (e.g., remove noise), improve contour detection accuracy (e.g., remove extraneous detected contours not indicative of a contour of the item container), and/or provide other image processing benefits. The sensor system 504 and/or the automated scanning system 500 can threshold the detected contours based on an area of interest. In some embodiments, the area of interest is the anticipated location of the placard (e.g., label, image) that has computer readable code (e.g., a barcode) within the image, such as on the item container that the vehicle is approaching. In some embodiments, the area of interest can be a portion of an image of an area of a facility where the sensor system 504 determines a container or object to be. The area of interest can then be analyzed for a label, barcode, placard, computer readable code on the container or object, without needing to analyze the entire image. Accordingly, the sensor system 504 and/or the automated scanning system 500 can threshold the area of the container depth image that depicts the item container.

In some embodiments, the sensor system 504 and/or the automated scanning system 500 can, through thresholding, distinguish contours associated with a target item container image 201 and object(s) image 270 such that the item container image 201 is isolated from the background and/or other object(s) image 270, resulting in the image shown in FIG. 11B. The sensor system 504 and/or the automated scanning system 500 can implement an algorithm that determines whether an item container is indeed present based on the detected distance, shape, size, movement, and/or other characteristics of the item container image 201.

The sensor system 504 and/or the automated scanning system 500 can trigger the camera system 506 and/or lighting system 508 if the item container image 201 is determined to indeed represent an item container 200 and that the detected item container 200 is within a suitable distance. The triggered lighting system 508 can illuminate the placard 202 positioned on the item container 200. The camera system 506 can capture a computer readable image of the placard 202. As explained elsewhere herein, the camera system 506 can focus on the placard 202 and, more specifically, can focus on computer readable information (e.g., a barcode) thereon as the vehicle moves relative to the item container 200. The image of the placard 202 can be read (e.g., by a computer) and, based on the read information, the item container 200 can be identified and the vehicle 502 or an operator thereof can be directed to move the item container 200 to a location.

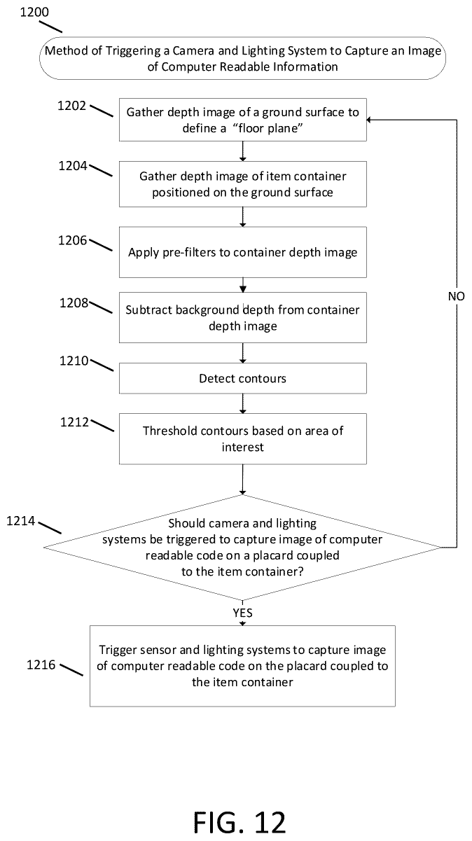

FIG. 12 is a flow diagram depicting an exemplary process 1200 of an auto-scan system triggering a camera system 506 and lighting system 508 to capture an image of a computer readable code on a placard 202 positioned on an item container 200. The flow diagram is provided for the purpose of facilitating description of aspects of some embodiments. The diagram does not attempt to illustrate all aspects of the disclosure and should be considered limiting.

The process 1200 beings a block 1202, wherein a sensor system 504 of the automated scanning system 500 gathers a depth image of a ground surface of a warehouse to define a “floor plane” (e.g., background depth). The sensor system 504 can have one or more sensors, as described elsewhere herein that can be used to gather depth images.

At block 1204, the sensor system 504 of the automated scanning system 500 gathers a depth image of an item container 200 positioned on the ground surface, also referred to as a container depth image. The depth image can depict the varying depths of the item container 200 relative to the surrounding ground surface. In some embodiments, the sensor system 504 can be activated by the vehicle 502, such as an AGV, as the vehicle 502 approaches the detected and/or anticipated location of the item container 200.

At block 1206, the sensor system 504 or the automated scanning system 500 applies pre-filter(s) to the container depth image. The pre-filter(s) can prepare the container depth image for further processing.

At block 1208, the sensor system 504 or the automated scanning system 500 can subtract the background depth (e.g., the floor plane) from the container depth image. The container depth image with the subtracted background depth can leave an image of the item container while removing the surrounding floor.

At block 1210, the sensor system 504 or the automated scanning system 500 can detect the contours shown in the container depth image with the subtracted background. This can result in the removal of extraneous depth indications that are not indicative of an item container.

At block 1212, the sensor system 504 or the automated scanning system 500 can threshold the detected contours. The sensor system 504 or auto-scan system 504 can threshold the detected contours based on an area of interest as described elsewhere herein. Thresholding can distinguish detected contours associated with a target item container and other objects.

At decision state 1214, the sensor system 504 or the automated scanning system 500 determines whether the camera system 506 and lighting system 508 should be triggered to capture an image of the computer readable code on a placard 202 coupled to the item container 200. The sensor system 504 or automated scanning system 500 can determine that the resulting container depth image is indeed indicative of an item container 200. The sensor system 504 or automated scanning system 500 can implement an algorithm that determines whether an item container 202 is indeed present based on the detected distance, shape, size, movement, and/or other characteristics of the resulting container depth image. The sensor system 504 and/or the automated scanning system 500 can determine that the detected item container 200 is within a suitable distance of the sensor system 504, camera system 506, or automated scanning system 500 to capture an image of the computer readable code on the placard 202 coupled to the item container 200. If the sensor system 504 and/or the automated scanning system 500 determines that the there is no item container 200 or the item container 200 is not within a suitable distance, the process 1200 proceeds to block 1202.

If the sensor system 504 and/or the automated scanning system 500 determine that there is indeed an item container 200 and the item container 200 is within a suitable distance, the sensor system 504 or automated scanning system 500 can trigger the camera system 506 and/or lighting system 508. The lighting system 508 can illuminate the placard 202 on the item container 200. The camera system 506 can capture an image of the illuminated placard 202 on the item container 200. The camera system 506 can have focus mechanisms, as described elsewhere herein, that facilitate the camera system 506 to focus on the placard 202 such that a suitable image is captured as the vehicle moves. The image of the placard 202 can be processed by the camera system 506 onboard the vehicle 502, communicated to the control system 520 to be read or interpreted, communicated to the surface visibility system 534 to be read or interpreted, and/or communicated to a remote server (relative to the vehicle 502) to be read or interpreted. Based on the read information, the item container 200 can be identified and/or the vehicle 502 or an operator thereof can be directed to move the item container 200 to a location.

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may comprise, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

Any methods disclosed herein need not be performed in the order recited. The methods disclosed herein include certain actions taken by a practitioner; however, they can also include any third-party instruction of those actions, either expressly or by implication. For example, actions such as “controlling a motor speed” include “instructing controlling of a motor speed.”

When the term processor or server is used herein, this can refer to a single processor or to one or more processors connected or networked together. The one or more processors can be located proximate to each other in one or more machines. The one or more processors can also be located remote from each other, in separate machines or computers, and can be in wired and/or wireless connection such as over a wide area network, the internet, a cellular system, and the like.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. In some embodiments, the computer system may be a cloud-based computing system whose processing resources are shared by multiple distinct business entities or other users.

Various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and steps described above. Whether such functionality is implemented in hardware or software depends upon the particular application and design constraints imposed on the overall system.

In one or more aspects, the functions described herein may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware. A person of skill in the art will understand that the functions and operations of the electrical, electronic, and computer components described herein can be carried out automatically according to interactions between components without the need for user interaction.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An automatic scanning system comprising:
a sensor system comprising one or more sensors, wherein the sensor system is configured to detect an item container;
a camera system comprising one or more cameras, wherein the camera system is configured to capture an image of a label on the item container; and
a control system configured to:
connect to a vehicle;
interpret sensor input from the sensor system; and
generate commands based on the interpreted sensor inputs to control the camera system.

2. The automatic scanning system of claim 1, wherein the control system is further configured to:
cause the sensor system to generate a background depth image of a ground surface of a facility to define a floor plane;
cause the sensor system to generate a container depth image of the item container positioned on the ground surface of the facility;
apply one or more pre-filters to the container depth image from the sensor system indicative of the item container;
subtract the background depth from the container depth image;
detect contours in the container depth image; and
threshold the detected contours in the container depth image.

3. The automatic scanning system of claim 2, wherein the control system is further configured to:
determine whether the container depth image is indicative of a presence of the item container;
determine whether the container depth image indicates that the item container is within a suitable distance of the sensor system; and
in response to determining that the container depth image is indicative of the presence of the item container and that the item container is within the suitable distance of the sensor system cause the camera system to capture an image of the label on the item container.

4. The automatic scanning system of claim 3, wherein the control system is further configured to communicate the image of the label on the item container to a surface visibility system, wherein the surface visibility determines a destination for the item container based on the image of the label.

5. The automatic scanning system of claim 1, wherein the sensor system comprises an RFID reader system configured to read an RFID tag on the item container.

6. The automatic scanning system of claim 1, wherein the camera system comprises a control board connected to the vehicle, the control board configured to receive one or more inputs from the vehicle.

7. The automatic scanning system of claim 6, wherein the input from the vehicle comprises an indication of movement of the vehicle, and wherein the control board is configured to adjust a focus mechanism of the camera system to image on item containers based on the indication of movement.

8. The automatic scanning system of claim 7, wherein the camera system further comprises a gear, which, when operated, adjusts the focus mechanism.

9. The automatic scanning system of claim 8, wherein the control board is configured to operate the gear based on the indication of movement.

10. The automatic scanning system of claim 1, wherein the vehicle is an automated guided vehicle.

11. A method of operating a vehicle, the method comprising:
detecting, via a sensor system located on a vehicle an item container;
capturing, via a camera system located on the vehicle, an image of a label on an item container;
interpreting, by one or more processors, sensor input from the sensor system; and
generating, by the one or more processors, commands based on the interpreted sensor inputs to operate the camera system.

12. The method of claim 11 further comprising:
generating, via the sensor system, a background depth image of a ground surface of a facility to define a floor plane;
generating, via the sensor system, a container depth image of the item container positioned on the ground surface of the facility;
applying, by the one or more processors, one or more pre-filters to the container depth image from the sensor system;
subtracting, by the one or more processors, the background depth from the container depth image;
detecting, by the one or more processors, contours in the container depth image; and
thresholding, by the one or more processors, the detected contours in the container depth image.

13. The method of claim 12 further comprising:
determining, in the one or more processors, that the container depth image is indicative of a presence of the item container;
determining that the container depth image indicates that the item container is within a suitable distance of the sensor system; and
in response to determining that the container depth image is indicative of the presence of the item container and that the item container is within a suitable distance of the sensor system, automatically causing the camera system to capture an image of the label on the item container.

14. The method of claim 11, wherein the vehicle is an automated guided vehicle.

15. The method of claim 11, wherein the sensor system comprises an RFID reader, and wherein detecting, the item container system comprises reading an RFID tag on the item container.

16. The method of claim 11, further comprising, receiving, in the camera system, one or more inputs from the vehicle.

17. The method of claim 16, adjusting a focus mechanism of the camera system in response to the one or more inputs from the vehicle.

18. The method of claim 17, wherein the one or more inputs comprise an indication of movement of the vehicle.

19. The method of claim 18, wherein adjusting the focus mechanism comprises operating a gear connected to the focus mechanism based on the indication of movement of the vehicle.

20. The method of claim 18 wherein the one or more inputs comprise a speed and direction of the vehicle.
